(19) United States
(12) Patent Application Publication
(10) Pub. No.: US 2006/0186637 A1
(43) Pub. Date: Aug. 24, 2006

(54) Adjustable trailer hitch receiver

(76) Inventor: Mark Scruggs, Walled Lake, MI (US)

Correspondence Address: MCDONALD HOPKINS CO., LPA, 2100 BANK ONE CENTER, 600 SUPERIOR AVENUE, E., CLEVELAND, OH, 44114-2653, US

(21) Appl. No.: 11/311,896

(22) Filed: Dec. 19, 2005

Related U.S. Application Data
(63) Continuation-in-part of application No. 11/146,403, filed on Jun. 6, 2005.
Application No. 11/146,403 is a continuation-in-part of application No. 10/726,149, filed on Dec. 2, 2003.
Application No. 10/726,149 is a continuation-in-part of application No. 10/660,995, filed on Sep. 12, 2003, now abandoned.
Application No. 10/660,995 is a continuation of application No. 10/459,272, filed on Jun. 11, 2003, now Pat. No. 6,746,038.
Application No. 10/459,272 is a continuation of application No. 10/235,334, filed on Sep. 5, 2002, now Pat. No. 6,601,868.
Application No. 10/235,334 is a continuation of application No. 09/865,277, filed on May 25, 2001, now Pat. No. 6,578,864.
Application No. 09/865,277 is a continuation of application No. 09/431,588, filed on Nov. 1, 1999, now abandoned.
(60) Provisional application No. 60/636,950, filed on Dec. 17, 2004.

(51) Int. Cl. B60D 1/14

(52) U.S. Cl. 280/495

(57) ABSTRACT

Receivers are attached to motor vehicles to tow a variety of objects such as trailers. Due to the variety of makes and models of motor vehicles, several different sized receivers are required to fit most motor vehicles. Accordingly, a receiver for mounting to a frame of a motor vehicle comprises a main frame member, first and second selectively positionable mounting flanges secured to the main frame member at selected first and second points, respectively, and a pair of mounting brackets capable of attachment to the first and second mounting flanges, each of the pair of mounting brackets having at least two mounting skirts capable of attaching to the frame of the motor vehicle.

### CROSS-REFERENCE TO RELATED APPLICATIONS

This application claims priority from U.S. Provisional Patent Application No. 60/636,950 filed on Dec. 17, 2004, which is hereby incorporated by reference, and is a continuation-in-part of pending U.S. patent application Ser. No. 11/146,403 filed on Jun. 6, 2005, which is a continuation-in-part of pending U.S. patent application Ser. No. 10/726,149 filed on Dec. 2, 2003, which is a continuation-in-part of U.S. patent application Ser. No. 10/660,995 filed Sep. 12, 2003, now abandoned, which is a continuation of U.S. patent application Ser. No. 10/459,272 filed on Jun. 11, 2003, now issued as U.S. Pat. No. 6,746,038, which is a continuation of U.S. patent application Ser. No. 10/235,334 filed on Sep. 5, 2002, now issued as U.S. Pat. No. 6,601,868, which is a continuation of U.S. patent application Ser. No. 09/865,277 filed May 25, 2001, now issued as U.S. Pat. No. 6,578,864, which is a continuation of U.S. patent application Ser. No. 09/431,588 filed Nov. 1, 1999, now abandoned.

### FIELD OF ART

The present invention relates to hitch assemblies for vehicles, and more specifically, to hitch assemblies that can be adjusted for mounting on various types of vehicle frames.

### BACKGROUND

It has long been known to construct trailer hitches that are mounted to vehicles in order to allow the towing of trailers or the like. Towing heavy payloads such as boats, campers, and trailers create considerable stress between the hitch receiver and the vehicle. As conventionally known, hitch assemblies are typically bolted directly to the vehicle's frame so as to distribute the considerable stress over the vehicle frame. Accordingly, properly attaching the trailer hitch to the vehicle is very important. In recent years, trailer hitches have been designed to include a central frame member or crossbar carrying mounting brackets at each end thereof for mounting the trailer hitch to the frame of the towing vehicle. The trailer hitches also include a receiver box having a rearwardly directed opening or cavity for the receipt of a hitch or draw bar that carries a hitch ball or other means allowing connection to a trailer. However, many types of current automotive frames cannot accept the standard hitch receiver design. Particularly, the standard hitch receiver provides a single bracket size for mounting to a vehicle. If that bracket size is inappropriate for a particular application, the bracket must be customized to be utilized with that particular application.

In recent years, vehicle manufacturers have offered not only an increasing number of vehicle options but also an increasing number of vehicle models. In order to avoid the manufacturing expense of custom designing and fitting a hitch receiver to each such vehicle model or each model with each available group of equipment options, it is necessary to provide a single hitch receiver with unparalleled mounting versatility to allow mounting to multiple vehicle models and vehicle models equipped with various option packages.

One effort made in the prior art to meet this need is disclosed in U.S. Pat. No. 5,149,122 to Helber. This adjustable hitch receiver merely allows one to alter the span of the frame mounting points and/or the height of the main frame or cross member. The apparatus is, however, relatively complicated and includes a number of parts to allow adjustability while providing for the mounting of the main frame member. Further, a conventional telescoping tubular construction is used and this introduces substantial play into the arrangement resulting in a detrimental loss in rigidity.

While the conventional hitch assemblies are adequate with regard to function, they possess two substantial disadvantages. First, today's auto-manufacturers have developed numerous slightly different specifications with respect to the undercarriage of vehicles. When these numerous vehicle specifications are combined with the conventional hitch receiver, it is often difficult or impossible to install such hitch assemblies due to their predetermined side bracket size and predetermined bolt patterns. Users are often forced to use a variety of adaptors, shims, nuts, and bolts in order to properly install the hitch receiver onto their vehicle.

### SUMMARY OF THE INVENTION

The present invention relates to a receiver for mounting to a frame of a motor vehicle comprises a main frame member, first and second selectively positionable mounting flanges secured to the main frame member at selected first and second points, respectively, and a pair of mounting brackets capable of attachment to the first and second mounting flanges, each of the pair of mounting brackets having at least two mounting skirts capable of attaching to the frame of the motor vehicle.

An alternative embodiment provides a receiver for mounting to a frame of a motor vehicle. The receiver comprises a main frame member having a cross member, first and second selectively positionable mounting flanges secured to the main frame member at selected first and second points, respectively first and second mounting brackets capable of attachment to the first and second mounting flanges, the first mounting bracket having first and second sets of mounting apertures and second mounting bracket having third and fourth sets of mounting apertures, and wherein the first and third sets of mounting apertures have a first bolt pattern capable of attachment to the frame of the motor vehicle, and wherein the second and fourth mounting apertures have a second bolt pattern capable of attachment to the frame of the motor vehicle, the second bolt pattern being different than the first bolt pattern.

In yet another alternative embodiment, a receiver for mounting to a frame of a motor vehicle comprises a main frame member having a cross member, first and second selectively positionable mounting flanges secured to the main frame member at selected first and second points, respectively, first and second mounting brackets capable of attachment to the first and second mounting flanges, each of the mounting brackets having first and second mounting skirts for attachment to the frame of the motor vehicle, wherein the first and second mounting skirts include a first set of mounting apertures and a second set of mounting apertures wherein the first set of mounting apertures have a first bolt pattern for attachment to the frame of the motor vehicle, and wherein the second mounting apertures have a second bolt pattern different than the first bolt pattern for attachment to the frame of the motor vehicle.

### DESCRIPTION OF THE DRAWINGS

For a better understanding of the descriptions disclosed herein reference may be made to the following illustrations, wherein:

FIG. 1 is a partially exploded, perspective view of an embodiment of a hitch receiver with mounting brackets mounted outboard of mounting flanges and with a first set of mounting apertures aligned with anchoring apertures;

FIG. 2 is a perspective view of the hitch receiver with the mounting brackets mounted outboard of the mounting flanges and with the second set of mounting apertures aligned with the anchoring apertures;

FIG. 3 is a perspective view similar to FIG. 1 but showing the mounting brackets mounted inboard of the mounting flanges, and once again with the first set of mounting apertures aligned with the anchoring apertures;

FIG. 4 is a rear side perspective view showing the clearance provided by the notch in the peripheral edge of one of the mounting brackets, which allows the necessary clearance for the cross member and thus, the inboard mounting of the mounting brackets;

FIG. 5 is a perspective view similar to FIG. 1 with the mounting brackets reversed so that the mounting skirts point outward or away from each other;

FIG. 6 is a detailed perspective view showing the mounting of the receiver box to the underside of the cross member through the mounting gusset;

FIG. 7 is a perspective view showing an alternative embodiment of the hitch receiver;

FIG. 8 is a perspective view of the alternative embodiment of the hitch receiver with the mounting brackets;

FIG. 9 is a perspective view of another alternative embodiment of the hitch receiver wherein the crossbar is in its raised position with the mounting brackets providing an upwardly facing first bolt pattern;

FIG. 10 is a perspective view of the hitch receiver of FIG. 9 wherein the crossbar is in its lowered position with the mounting brackets adjusted to provide an upwardly facing second bolt pattern; and

FIG. 11 is a perspective view of the hitch receiver wherein the mounting flanges are mounted to the exterior of the mounting brackets.

### DETAILED DESCRIPTION

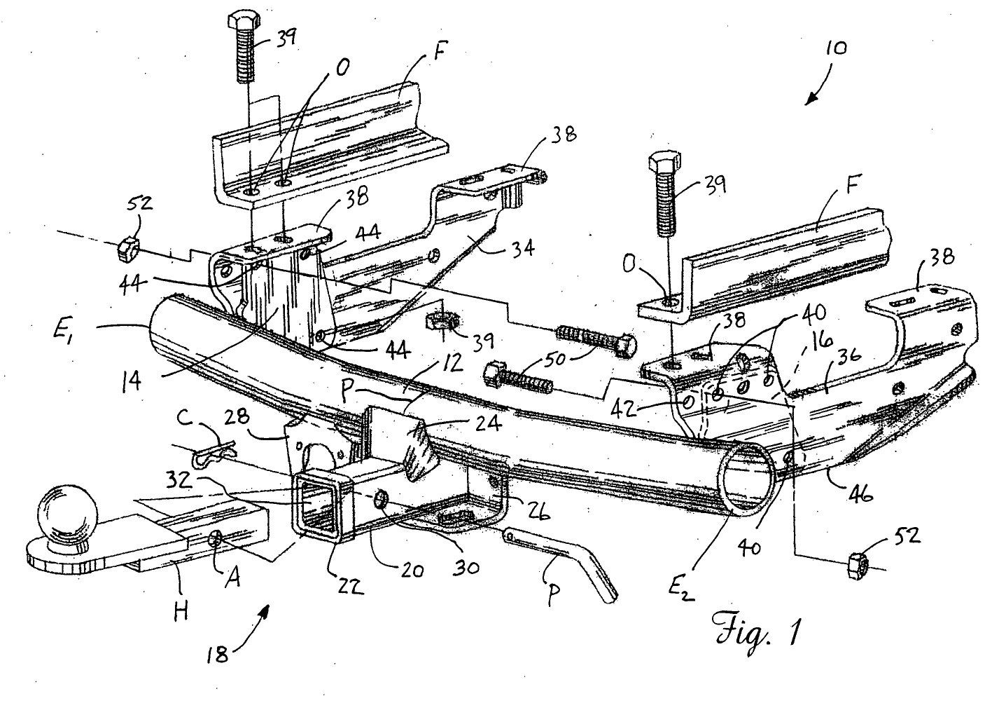

Reference is now made to FIG. 1 showing a hitch receiver 10. The hitch receiver 10 includes a main frame member 11 preferably formed from tubular steel material. As clearly illustrated, the main frame member 11 includes a cross member 12 that may have a round cross section. The cross member 12 includes a first end E₁, and a second end E₂, and a midpoint P.

A first selectively positionable mounting flange 14 is secured to the cross member 12 at a selected first point between the first end E₁ and the midpoint P of the cross member 12. Similarly, a second mounting flange 16 is secured to the cross member 12 at a selected point between the second end point E₂ and the midpoint P of the cross member 12. Advantageously, by altering or adjusting the positioning of the two flanges 14, 16 along the cross member 12, the spacing between them may be varied to provide a custom fit with the frame of substantially any towing vehicle.

Each mounting flange 14, 16 may be formed from steel plate material. The flanges 14, 16 may be secured to the cross member 12 in substantially any appropriate manner including but not limited to welding or mechanical fasteners. An accessory receiver in the form of a hitch receiver box assembly 18 is carried at the middle of the main frame member 11 on the cross member 12. The hitch receiver box assembly 18 includes a receiver box 20 formed from a steel torque tube and including a reinforced lip 22. Additionally, the hitch receiver box assembly 18 includes an overlying mounting gusset 24 and a substantially L-shaped chain plate 26. The receiver box 20, gusset 24 and chain plate 26 are all welded together to the cross member 12 for strength and rigidity. Of course, other means of securing the hitch receiver box assembly 18 to the cross member 12 known in the art to be appropriate for this purpose may be utilized. In addition, a bracket 28 for supporting an electrical plug to power the trailer lighting system as well as any electrical trailer braking system may be secured to the chain plate 26 and/or the cross member 12 (as shown) in a manner well known in the art.

As should be further appreciated from FIG. 1, the receiver box 20 includes aligned cooperating apertures 30 in the sidewalls thereof (only one shown in FIG. 1). As is known in the art, a hitch or tow bar H is inserted in the rearward opening cavity 32 until a through aperture A in the hitch bar is aligned with the apertures 30 in the receiver box 20. A connecting pin P is then inserted through the aligned apertures 30 in the receiver box 20 and the aperture A in the hitch bar H. A pin clip C is then secured to the projecting end of the connecting pin P to secure the connecting pin in position and, therefore, the hitch bar H in the receiver box 20.

The receiver 10 is mounted to the towing vehicle by means of first and second mounting brackets 34, 36. Each mounting bracket 34, 36 is formed from a single piece of sheet metal that is forged or otherwise machined so as to provide at least in part two planar surfaces extending substantially perpendicular to one another; that is, a substantially L-shape in cross-section. In this way each mounting bracket 34, 36 includes at least one integral mounting skirt 38. In the embodiment illustrated, each mounting bracket 34, 36 includes a pair of spaced, integral mounting skirts 38. Each mounting skirt 38 includes a pair of openings 37 through which fasteners 39 may be utilized to secure the mounting brackets 34, 36 through cooperating openings 0 drilled in the frame F of the towing vehicle.

As best shown with reference to FIGS. 1-3, each of the mounting brackets 34, 36 includes a first mounting arrangement comprising a first set of four mounting apertures 40. Additionally, each mounting bracket 34, 36 includes a second mounting arrangement comprising a second set of four mounting apertures 42. It should be appreciated that one of the mounting apertures 40/42 is shared by each set. The first set of mounting apertures 40 defines a first rectangular spatial arrangement. The second set of mounting apertures 42 define a second rectangular spatial arrangement identical in shape and orientation to the first rectangular arrangement but offset therefrom a given selected distance preferably between 1.970 and 2.030 inches. Further, it should be appreciated that each arrangement defined by the first mounting apertures 40 and the second mounting apertures 42 correspond exactly in shape and orientation to the arrangement of anchoring apertures 44 provided in each of the mounting flanges 14,16.

By aligning the first set of mounting apertures 40 of the mounting brackets 34, 36 with the anchoring apertures 44 in the first and second mounting flanges 14, 16, the mounting brackets are secured to the cross member 12 in a first selected position. Alternatively, by aligning the second set of mounting apertures 42 in the mounting brackets 34, 36 with the anchoring apertures 44 in the first and second mounting flanges 14, 16, the mounting brackets are mounted to the cross member 12 in a second alternative position. Accordingly, it should be appreciated that the present invention allows fore and aft adjustment of the relative position of the mounting brackets 34, 36 on the cross member 12.

It should be appreciated that in either of these positions, the cross member 12 is mounted in a cantilever fashion. This is because the cross member 12 is mounted to the mounting flanges 14, 16 adjacent a first or rear end thereof while all of the anchoring apertures 44 are provided adjacent a second or front end thereof; that is, all of the mounting apertures 44 are provided on the two mounting flanges 14, 16 in front of cross member 12. This structural arrangement advantageously allows for good hardware accessibility thereby simplifying vehicle installation. Further, this is accomplished while maintaining desirable hitch to body clearance. In addition, it provides good hitch box location.

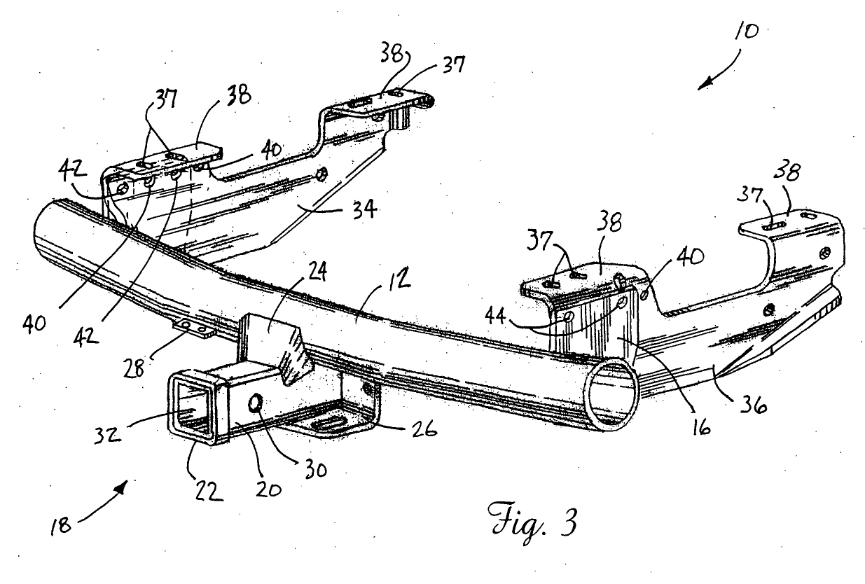

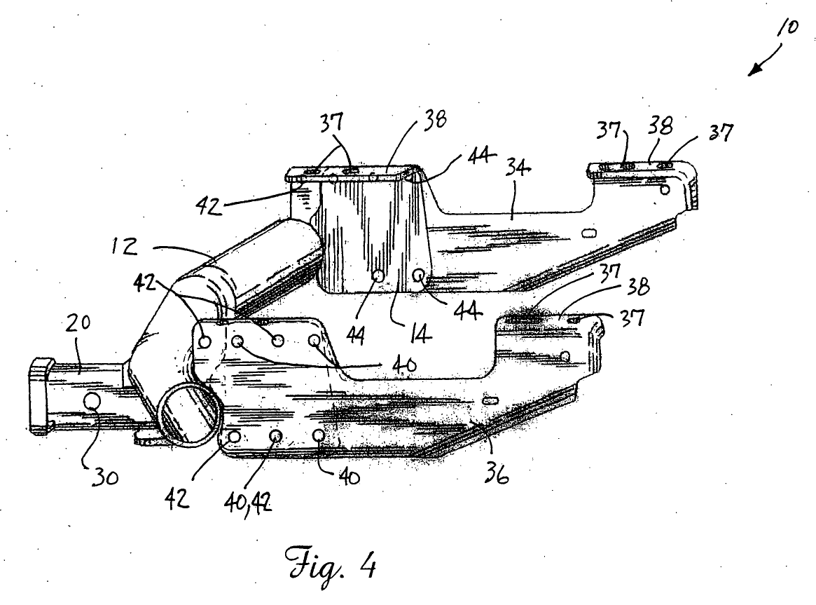

Additionally, it should be appreciated with reference to FIGS. 1-3, the mounting brackets 34, 36 may be mounted outboard of the mounting flanges 14, 16 as shown in FIGS. 1, 2 and 5 or inboard of the mounting flanges as shown in FIGS. 3 and 4.

It should also be appreciated that the peripheral edge 46 of each mounting bracket 34, 36 defines a notch 48. The notch 48 provides the necessary clearance for the edge of the mounting brackets 34, 36 to extend around the cross member 12 while allowing the first set of mounting apertures 40 to be aligned with the anchoring apertures 44 of the mounting flanges 14, 16.

In use, the receiver installer first determines the model of the vehicle to which the hitch receiver 10 is to be connected. He then reviews the equipment options and/or accessories on the vehicle particularly including any exhaust system and suspension system modifications that might affect the mounting of the hitch receiver 10 to the vehicle frame.

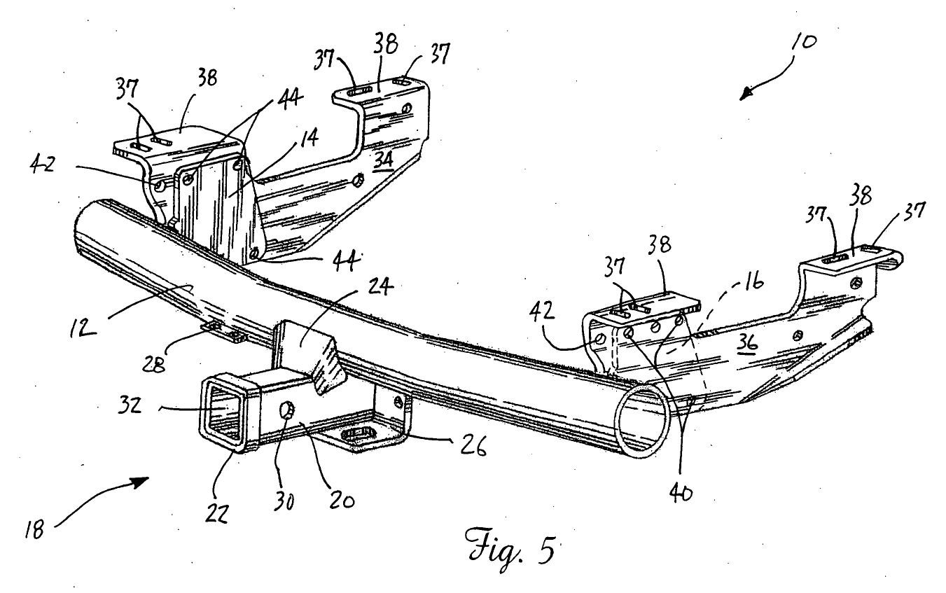

After completing this background review, the mounting brackets, 34, 36 are secured to the mounting flanges 14, 16 that have the desired spacing along the cross member 12. More specifically, the mounting brackets 34, 36 may be oriented as shown in FIGS. 1-4 with the mounting skirts 38 projecting inwardly toward each other or they may be reversed as shown in FIG. 5 with the mounting skirts 38 projecting outwardly away from each other. This allows additional side-to-side or span adjustment for mounting on vehicle frames of varying width.

If the mounting brackets 34, 36 are to be secured inboard of the mounting flanges 14, 16, the first set of mounting apertures 40 in the mounting brackets are aligned with the anchoring apertures 44 in the mounting flanges 14, 16 (see FIGS. 3 and 4). Fasteners in the form of bolts 50 and cooperating locknuts 52 are then used to secure the mounting brackets 34, 36 in the desired position.

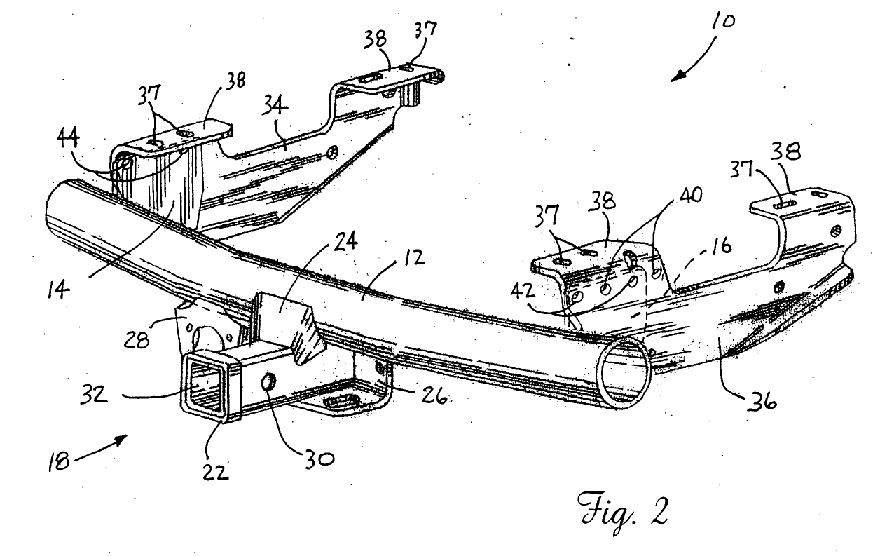

Whether the mounting brackets 34, 36 are to be mounted inboard or outboard of the mounting flanges 14, 16, fore and aft adjustment is also possible. In the fore or first position, the first mounting apertures 40 are aligned with the anchoring apertures 44 and the bolts 50 and the locknuts 52 are utilized to secure them in position (see FIG. 2). In the aft or second position, the second mounting apertures 42 are aligned with the anchoring apertures 44 and the bolts 50 and cooperating locknuts 52 are utilized to secure them in position (see FIGS. 1 and 5). The inboard or outboard and fore or aft positioning of the mounting brackets 34, 36 with respect to the cross member 12 is dictated by the make, model and option or accessory packages of the towing vehicle. Whichever arrangement allows the most convenient and effective mounting of the receiver 10 to the frame of the towing vehicle is the one that is utilized.

After the selection is made, the receiver 10 is lined up on the frame F and a drill is utilized to drill mounting openings 0 in the frame of the towing vehicle which are aligned with the mounting openings 37 in the mounting skirts 38. Fasteners 39, such as cooperating bolts and locknuts, are then utilized to complete the connection between the receiver 10 and the vehicle frame F. Specifically, the bolts are inserted through the openings 37 in the mounting skirts 38 and the cooperating openings cut in the vehicle frame. The locknuts are then tightened to secure the connection.

Of course, in any of these various mounting positions, the planar configuration of the mounting brackets 34, 36 insures a narrow transverse profile and the necessary clearance to fit into tight areas such as between vehicle exhaust, suspension and frame components. Further, since each of the mounting brackets 34, 36 is a unitary or single-piece component connected directly between the main frame member 11 and the vehicle frame rigid connection is insured.

In accordance with an additional aspect of the present invention, it should be appreciated that the receiver box 20 is mounted underneath the cross member 12. In prior art hitch receiver designs incorporating a cross member with a circular cross section the receiver box is mounted through the cross member. Numerous benefits result from the underneath mounting of the receiver box in accordance with the present invention.

Since the receiver box 20 projects below the cross member 12, the cross member may be mounted further up from the ground behind the body work of the towing vehicle. There it is less visible and this is more aesthetically pleasing. Additionally, the mounting brackets 34, 36 may be made with a lower height profile from less material. They are therefore cheaper to make and weigh less. As a result, the hitch receiver 10 is relatively light weight and easier to manipulate during installation. Further, since the cross member 12 may be mounted closer to the vehicle frame, the centroid axis of the cross member is closer to the mounting points. As a result, the moment arm is shortened thereby reducing the stress and bending force applied to the brackets during towing.

The secure mounting of the receiver box 20 to the cross member 12 is primarily achieved through the mounting gusset 24. The mounting gusset 24 is formed to bring a contoured upper edge 50 into substantially continuous load bearing engagement with the cross member 12 and a contoured lower edge 52 into substantially continuous load bearing engagement with the upper and side walls of the receiver box 20. Weld points along the intersection of these edges 50, 52 with the cross member 12 and receiver box 20 complete a high integrity connection.

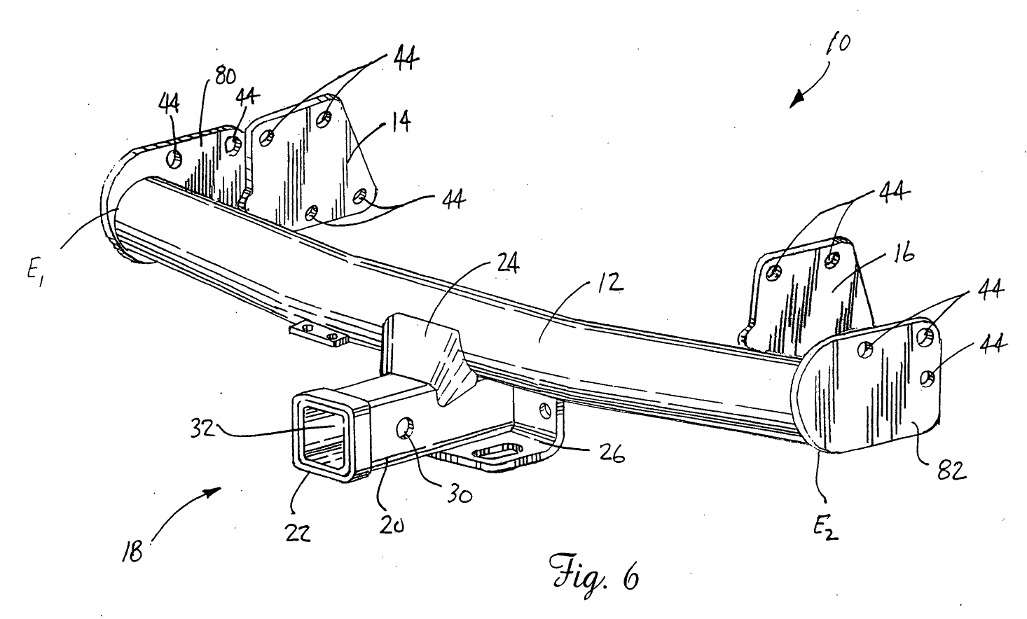

FIG. 6 illustrates an alternative embodiment of the present invention. The receiver 10 of FIG. 6 includes a cross member 12, a first mounting flange 14, a second mounting flange 16, a hitch receiver box assembly 18, and first and second mounting brackets 34, 36 just like the previous embodiments. In addition, the receiver 10 includes a third mounting flange 80 mounted to the cross member 12 at the first end E₁ and a fourth mounting flange 82 mounted to the cross member at the second end E₂.

In the illustrated embodiment, the first and second mounting flanges 14, 16 are aligned in a first plane while the third and fourth mounting flanges 80, 82 are aligned in a second, different plane. As shown, the first plane is above the second plane. In certain applications such an arrangement may be desired to provide the necessary clearance between the third and fourth flanges 80, 82 and various vehicle components in order to allow the receiver 10 to be mounted to the vehicle by means of the mounting brackets 34, 36 carried on the first and second flanges 14, 16.

For other applications, it may be desirable to have all four flanges 14, 16, 80, 82 in the same plane. For still others, it may be desirable to have the third and fourth mounting flanges 80, 82 in a plane above the first and second mounting flanges 14, 16. Still further, it should be appreciated that the mounting brackets 34, 36 may be mounted to the third and fourth flanges 80, 82 instead of the first and second flanges 14, 16 in order to allow proper mounting of the hitch receiver 10 to the frame of certain vehicles. Advantageously, the different spacing between the first and second flanges 14, 16 and the third and fourth flanges 80, 82 allow one hitch receiver 10 to fit may more makes and models of vehicles. Accordingly, one may maintain a smaller parts inventory and still meet all customer needs.

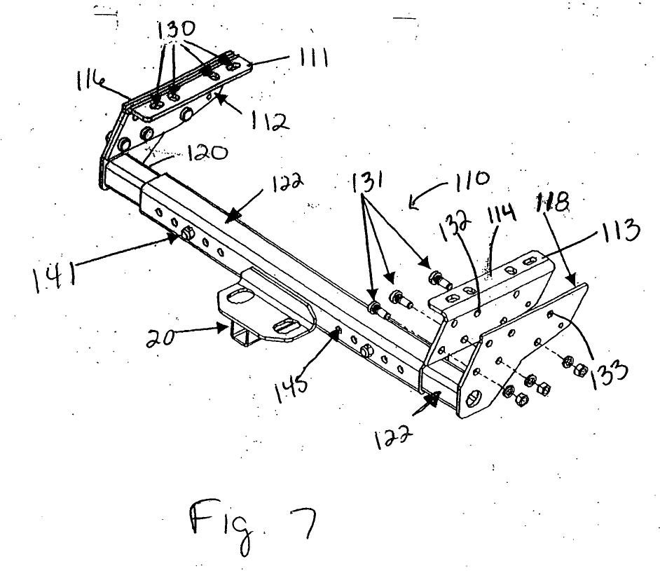

FIG. 7 illustrates an additional alternative embodiment of the present invention. The alternative embodiment of the hitch receiver 110 comprises first and second mounting brackets 112, 114 removably attachable to first and second mounting flanges 116, 118. The first and second mounting flanges 116, 118 are attached, either removably or non-removably, to first and second extension tubes 120, 121 respectively. A cross member 122 is telescopically received within the extension tubes 120, 122 at either end thereof. Finally, a receiver box 20 is attached to the cross member 122 as discussed above.

The first and second mounting brackets 112, 114 are capable of removable attachment to the vehicle frame via mounting skirts 111, 113 and to first and second mounting flanges 116, 118. The first and second mounting brackets 112, 114 are attached to the vehicle's frame via fasteners (not shown) passing through apertures 130 in said first and second mounting brackets 112, 114, or more particularly, in the skirts 111, 113 thereof. This is similar to the method of attaching the first and second mounting brackets of the alternative embodiments above. The first and second mounting brackets 112, 114 are removably attached to the first and second mounting flanges 116, 118 by fasteners 131 attaching to a set of mounting apertures 132 and a set of anchoring apertures 133 in the first and second mounting brackets 112, 114 and the first and second mounting flanges 116, 118, respectively. As shown in FIG. 7, the fasteners 131 are bolts, washers, and nuts. It should be understood, however, that other such fasteners may be used, not just those shown in FIG. 7.

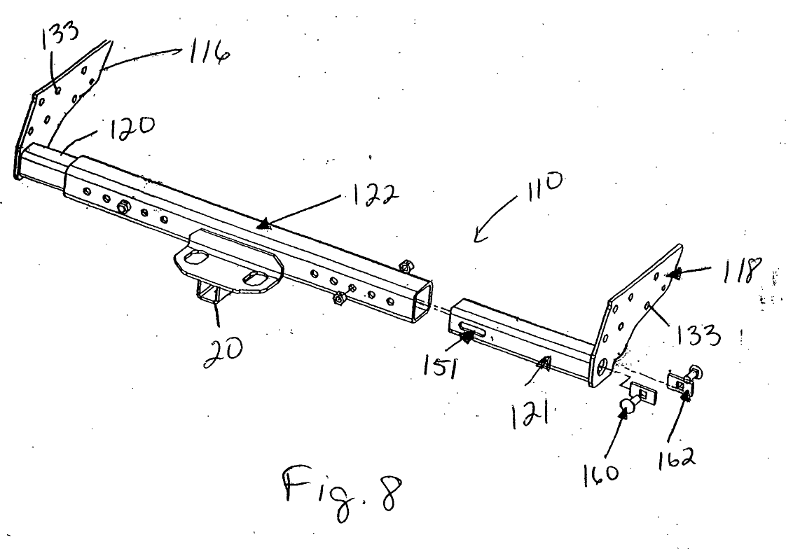

The cross member 122 is located between the first and second mounting flanges 116, 118. The cross member 122 telescopically engages both the first and second extension tubes 120, 121 and is attached thereto by fasteners 141. The fasteners 141 can be nuts and bolts shown in FIG. 7, or alternatively, can be any other sort of fastener. The fasteners 141 pass through a set apertures 145 in both sides of the cross member 122. The apertures 145 are on both sides of the cross member 122 such that the fastener 141 can extend therethrough. Alternatively, the apertures 145 may receive the fastener 141 without the necessity of passing therethrough. In another alternative embodiment, the apertures 145 may only be on one side of the cross member 122. As shown in FIG. 8, the fasteners 145 may also pass through an oblong aperture 151 in the first and second extension tubes 120, 121.

By utilizing the present embodiment of the first and second mounting brackets 112, 114 and the first and second mounting flanges 116, 118 instead of a one-piece design, the user is able to take advantage of numerous possible configurations for the hitch receiver 110. For example, the first and second mounting brackets 112, 114 can be attached to the first and second mounting flanges 116, 118 in a raised vertical position (up) or a lowered vertical (down) position. In addition to, or alternatively, the first and second mounting brackets 112, 114 can be attached to the first and second mounting flanges 116, 118 fore or aft. The position of the apertures 133 located on the first and second mounting flanges 116, 118 and the position of the set of mounting apertures 132 on the first and second mounting brackets 112, 114 allow the hitch receiver 110 to be attached to the vehicle in several different positions, including, without limitation vertical and horizontal positions. The set of mounting apertures 132 and anchoring apertures 133 are in a predetermined pattern such that several different configurations of the hitch receiver 110 are possible. While two vertical configurations and two horizontal configurations are shown in the drawings, any number of such configurations can be accomplished.

Additionally, the first and second mounting brackets 112, 114 may also be mounted on the interior or exterior of the first and second mounting flanges 116, 118. Further, the first and second mounting brackets 112, 114 can be connected to the first and second mounting flanges 116, 118 with the apertures 130 of the first and second mounting brackets 112, 114 facing either inwardly or outwardly. In other words, the skirts 111, 113 of the first and second mounting brackets 112, 114 are reversible.

This embodiment, shown in FIG. 8 of the hitch receiver 110 provides increased mounting adjustability between the cross member 122 and the first and second extension tubes 120, 121. This is accomplished by utilizing fasteners 160 that connect to a bolt plate 162 that rests on the interior of the first and second extension tubes 120, 121. Where conventional hitch assemblies have bolts and nuts that apply force on the outer portion of the transverse tube, the present fastener 160 applies force directly between the interior of the first and second extension tubes 120, 121 via the oblong aperture 151 (only one of which is shown in FIG. 8) and the exterior of the first and second cross members 120, 121. This force permits greater connection strength and greater provision in allowing the cross member 122 to slide back-and-forth between the first and second mounting flanges 114, 116 prior to tightening.

The design of the receiver 10 and 110 allows the selective positioning of the mounting brackets 34, 36, 112, 114 on the cross member 12, 122 either inboard or outboard of the mounting flanges 14, 16, 116, 118. Additionally, fore and aft adjustment is possible by aligning the first set of mounting apertures 40 or the second set of mounting apertures 42 in the mounting brackets 34, 36 with the anchoring apertures 44 in the mounting flanges 14, 16. Additionally, vertical and fore and aft adjustment is possible by aligning the first set of mounting apertures 132 in the first and second mounting brackets 112, 114 with the apertures 133 in the first and second mounting flanges 114, 116. Finally, the hitch receiver 110 is further adjustable using the telescoping first and second extension tubes 120, 121 with the cross member 122. Accordingly, adjustment in several positions is possible. For example, adjustment is possible in as many as two directions, fore and aft, in four directions, fore, aft up, and down, or even in five directions, fore, aft, up, down, and an additional horizontal adjustment. In this way, significant mounting versatility is provided so that the receiver 10 may be used for multiple applications; that is, on various makes, models and option and accessory equipped towing vehicles.

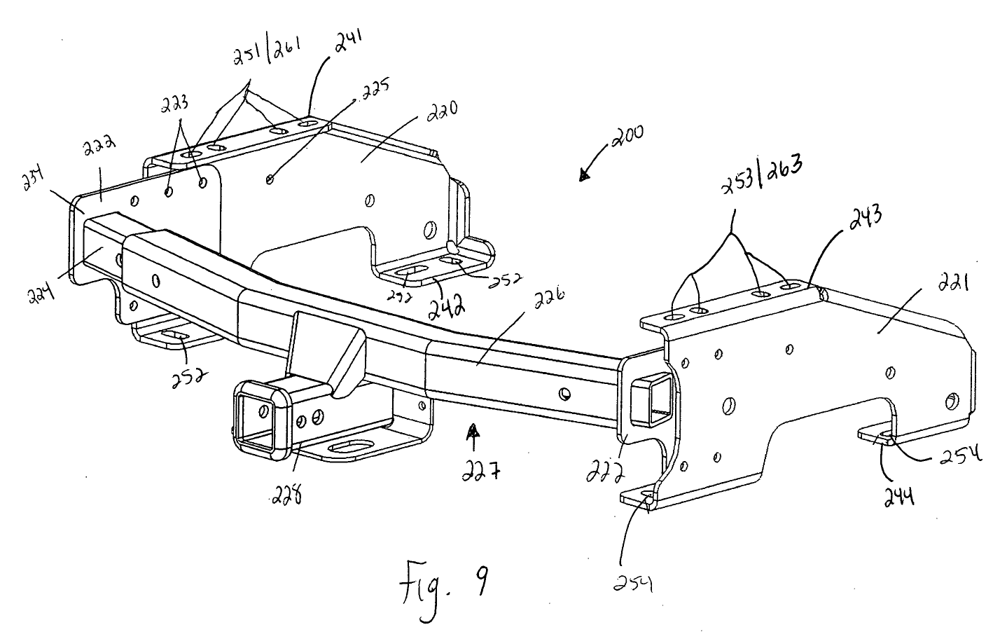

Referring to FIG. 9, the hitch receiver 200 of another alternative embodiment is shown. This embodiment of the hitch receiver 200 comprises two mounting brackets, a first mounting bracket 220 and a second mounting bracket 221, two mounting flanges 222, which are connected to an extension tube 224. Further, the hitch receiver 200 comprises a main frame member 227 that includes a cross member 226 for telescopically receiving the extension tubes 224 at either end thereof, and a receiver box 228.

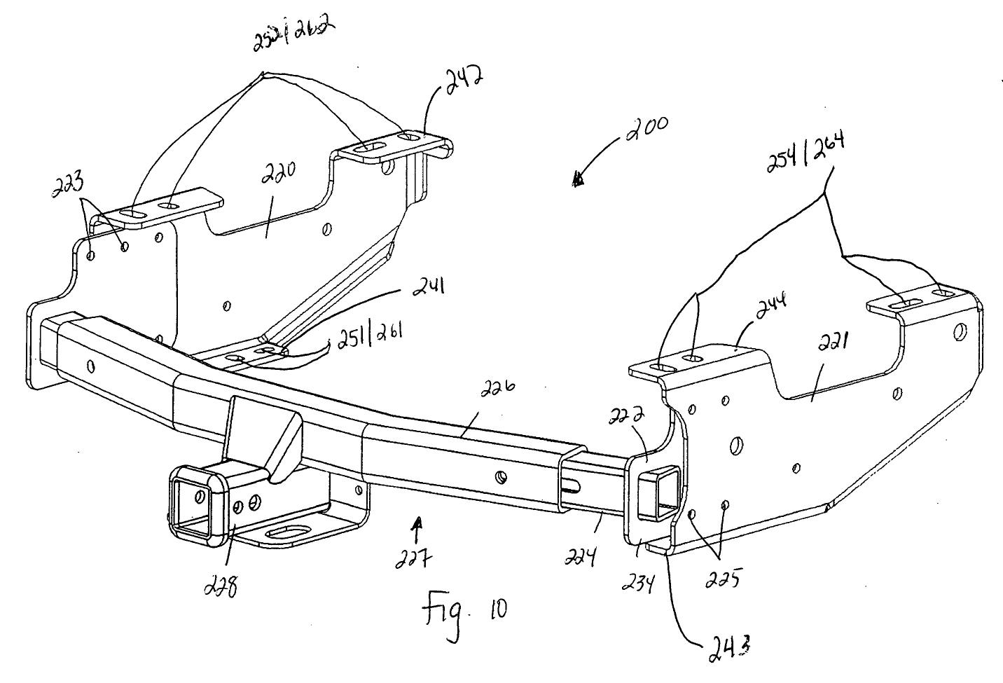

The first and second mounting brackets 220, 221 have multiple bolt patterns therein for independent attachment to the frame of a vehicle. As shown in FIG. 9, the first mounting bracket 220 has first and second mounting skirts 241, 242 and the second mounting bracket 221 has third and fourth mounting skirts 243, 244. The first mounting skirt 241 has a first set of mounting apertures 251 having a first mounting bolt pattern 261 for connection to a vehicle frame and the second mounting skirt 242 has a second set of mounting apertures 252 having a second mounting bolt pattern 262 for connection to a vehicle frame, as better shown in FIG. 10. Likewise, the third mounting skirt 243 has a third set of mounting apertures 253 having a third mounting bolt pattern 263 for connection to a vehicle frame and the fourth mounting skirt 244 has a fourth set of mounting apertures 254 having a fourth mounting bolt pattern 264 for connection to a vehicle frame, as better shown in FIG. 10. It should be understood that the first and third mounting skirts 241, 243 may be substantially identical and the second and fourth mounting skirts 242, 244 may be substantially identical. This would mean that the first and third sets of mounting apertures 251, 253 have substantially the same mounting bolt patterns such that the first and third mounting bolt patterns 261, 263 are substantially identical. Similarly, the second and fourth set of mounting apertures 252, 254 may have substantially the same mounting bolt patterns such that the second and fourth mounting bolt patterns 262, 264 are substantially identical. Stated another way, the first and second mounting brackets 220, 221 may include a first mounting skirt 241, 243 and a second mounting skirt 242, 244. The first mounting skirt 241 would include a first set of mounting apertures 251, 253, and the second mounting skirt 242 would include a second set of mounting apertures 252, 254. Finally, the first set of mounting apertures 251, 253 would include a first mounting bolt pattern 261, 263, and the second set of mounting apertures 252, 254 would include a second mounting bolt pattern 262, 264.

As shown in FIG. 9, the first and second mounting brackets 220, 221 are positioned in a first position whereby the first and third mounting bolt patterns 261, 263 (which can also be stated as just the first mounting bolt pattern) extend upward toward the frame of the vehicle. This also results in the second and fourth mounting bolt patterns 262, 264 extending downward away from the frame of the vehicle. Accordingly, these bolt patterns can be used to attach the mounting brackets 220, 221 through the use of bolts, washers, and nuts (or some other combination of fasteners), and therefore, the receiver to the frame of the vehicle.

Alternatively, the mounting brackets 220, 221 can be inverted to a second position whereby the mounting brackets 220, 221 can be oriented as shown in FIG. 10. As shown in FIG. 10, the second and fourth mounting bolt patterns 262, 264 (which can also be stated as just the second mounting bolt pattern) extend upward toward the frame of the vehicle. This also results in the first and third mounting bolt patterns 261, 263 extending downward away from the frame of the vehicle. Accordingly, these bolt patterns can be used to attach the mounting brackets 220, 221 through the use of bolts, washers, and nuts (or some other combination of fasteners), and therefore, the receiver to the frame of the vehicle. As such, the adjustable orientation of the mounting brackets 220, 221 provides the hitch receiver 200 with at least two distinct bolt patterns for connection to a vehicle frame. Through the bolt pattern, the mounting brackets 220, 221 are attached to the vehicle's frame via carriage bolts (or other fasteners) passing through the mounting apertures of the bolt patterns.

Mounting flanges 222 comprise a plate-like member having a series of apertures 223 located therein. These apertures 223 correspond to apertures 225 located in the mounting brackets 220, 221 for adjustable fore and aft connection between the mounting flanges 222 and the mounting brackets 220, 221 through the use of bolts, washers, and nuts (or some other combination of fasteners). Mounting flanges 222 further include an extended portion 234 having an extension tube 224 mounted thereto. Mounting flanges 222 generally comprise an L-shaped member wherein the foot of the L-shaped member comprises the extended portion 234 and can be mounted in an up or down alternative arrangement to the mounting brackets 220, 221 as shown in FIG. 9 (extended portion up orientation) and FIG. 10 (extended portion down orientation). These two orientations permit the cross member 226 and attached receiver box 228 to be mounted to the vehicle frame at two distinct heights. This allows for the maximum ground to hitch height and/or minimum gap between hitch and bumper.

The cross member 226 is telescopically mounted between the extension tubes 224 of the mounting flanges 222 and fixed thereto by nuts and bolts (or other fasteners) that pass through at least a pair of apertures in the cross member 226. These fasteners also pass through corresponding apertures (see FIG. 9) and an oblong aperture (see FIG. 10) in the extension tube 224. Therefore, the cross member 226 can telescopically adjust longitudinally relative to the mounting flanges 222 to correspond to various required widths. It should be noted that the extension tubes 224 and the cross member 226 can be of any configuration so long as they telescopically engage at their ends (e.g. square, round, etc.).

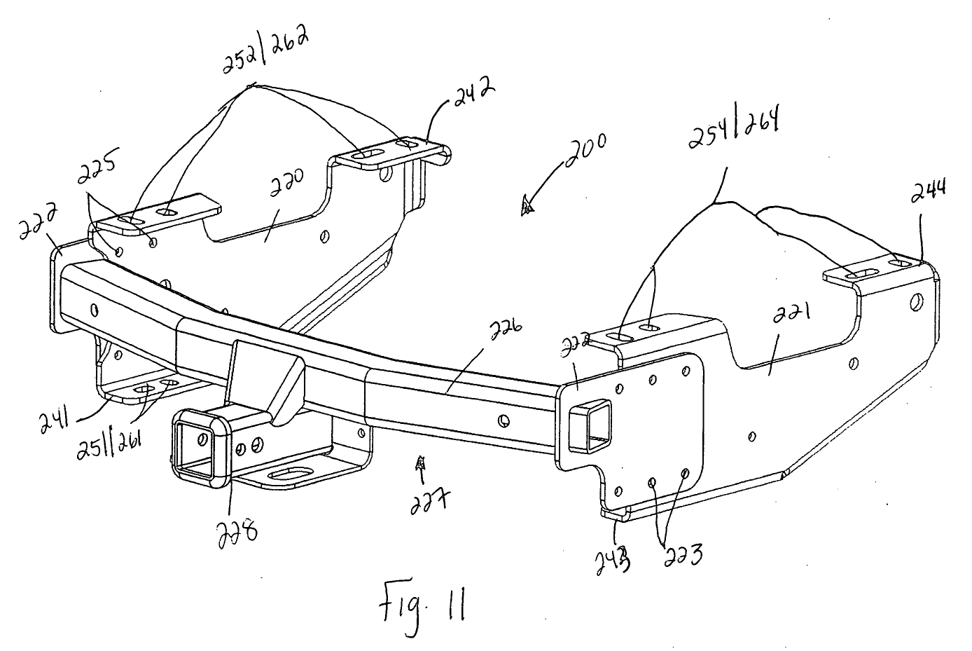

FIG. 11 discloses the components of the above-described hitch receiver 200 where the mounting flanges 222 are mounted to the exterior of the mounting brackets 220. Therefore, with the mounting flanges 222 capable of being mounted to the mounting brackets 220, 221 along the interior or exterior of the mounting brackets 220, 221 and capable of being mounted fore and aft along the mounting brackets 220, 221, a significant number of configurations can be provided through the utilization of these components based upon the needs of the user.

The foregoing description of the embodiments of the invention has been presented for purposes of illustration and description. It is not intended to be exhaustive or to limit the invention to the precise form disclosed. Obvious modifications or variations are possible in light of the above teachings. These embodiments were chosen and described to provide illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and embodiments disclosed are not intended to limit the ordinary meaning of the claims and their broad interpretation in any way.

Having thus described the invention, I claim:

1. A receiver for mounting to a frame of a motor vehicle comprising:
a main frame member;
first and second selectively positionable mounting flanges secured to said main frame member at selected first and second points, respectively; and
a pair of mounting brackets capable of attachment to said first and second mounting flanges, each of said pair of mounting brackets having at least two mounting skirts capable of attaching to said frame of said motor vehicle.

2. The receiver of claim 1, wherein said main frame member includes a cross member.

3. The receiver of claim 2, wherein said pair of mounting brackets include a first mounting bracket having first and second mounting skirts and a second mounting bracket having third and fourth mounting skirts.

4. The receiver of claim 3, wherein said first mounting skirt includes a first set of mounting apertures and said second mounting skirt includes a second set of mounting apertures wherein said first set of mounting apertures have a first bolt pattern for attachment to said frame of said motor vehicle, and wherein said second mounting apertures have a second bolt pattern different than said first bolt pattern for attachment to said frame of said motor vehicle.

5. The receiver of claim 4, wherein said third mounting skirt includes a third set of mounting apertures and said fourth mounting skirt includes a fourth set of mounting apertures wherein said third set of mounting apertures have a third bolt pattern for attachment to the frame of the motor vehicle, and wherein said fourth mounting apertures have a fourth bolt pattern different than said third bolt pattern for attachment to said frame of said motor vehicle.

6. The receiver of claim 5, wherein said first and second mounting brackets are positionable to a first position wherein said first and third mounting skirts extend upward toward said frame and said second and fourth mounting skirts extend downward away from said frame.

7. The receiver of claim 6, wherein said first and second mounting brackets are positionable to a second position wherein said second and fourth mounting skirts extend upward toward said frame and said first and third mounting skirts extend downward away from said frame.

8. The receiver of claim 7, wherein said first and second mounting brackets are invertible to go from said first position to said second position.

9. The receiver of claim 2, wherein said pair mounting brackets is mounted outboard of said mounting flanges.

10. The receiver of claim 2, wherein said pair mounting brackets is mounted inboard of said mounting flanges.

11. The receiver of claim 3, wherein said mounting brackets are reversible so that said mounting skirts extend inwardly, toward each other or outwardly, away from each other.

12. The receiver of claim 5, wherein said first bolt pattern is substantially identical to said third bolt pattern and said second bolt pattern is substantially identical to said fourth bolt pattern.

13. A receiver for mounting to a frame of a motor vehicle comprising:
a main frame member having a cross member;
first and second selectively positionable mounting flanges secured to said main frame member at selected first and second points, respectively;
first and second mounting brackets capable of attachment to said first and second mounting flanges, said first mounting bracket having first and second sets of mounting apertures and second mounting bracket having third and fourth sets of mounting apertures; and
wherein said first and third sets of mounting apertures have a first bolt pattern capable of attachment to said frame of said motor vehicle, and wherein said second and fourth mounting apertures have a second bolt pattern capable of attachment to said frame of said motor vehicle, said second bolt pattern being different than said first bolt pattern.

14. The receiver of claim 13, wherein said first and second mounting brackets are positionable to a first position where said first and third mounting apertures extend upward toward said frame and said second and fourth mounting apertures extend downward away from said frame.

15. The receiver of claim 14, wherein said first and second mounting brackets are positionable to a second position where said second and fourth mounting apertures extend upward toward said frame and said first and third mounting apertures extend downward away from said frame.

16. The receiver of claim 15, wherein said first and second mounting brackets are invertible to go from said first position to said second position.

17. A receiver for mounting to a frame of a motor vehicle comprising:
a main frame member having a cross member;
first and second selectively positionable mounting flanges secured to said main frame member at selected first and second points, respectively;
first and second mounting brackets capable of attachment to said first and second mounting flanges, each of said mounting brackets having first and second mounting skirts for attachment to said frame of said motor vehicle;
wherein said first and second mounting skirts include a first set of mounting apertures and a second set of mounting apertures wherein said first set of mounting apertures have a first bolt pattern for attachment to said frame of said motor vehicle, and wherein said second mounting apertures have a second bolt pattern different than said first bolt pattern for attachment to said frame of said motor vehicle.

18. The receiver of claim 17, wherein said first and second mounting brackets are positionable to a first position where said first mounting skirts extend upward toward said frame and said second mounting skirts extend downward away from said frame.

19. The receiver of claim 18, wherein said first and second mounting brackets are positionable to a second position where said second mounting skirts extend upward toward said frame and said first mounting skirts extend downward away from said frame.

20. The receiver of claim 19, wherein said first and second mounting brackets are invertible to go from said first position to said second position.
